(19) United States
(12) Patent Application Publication
(10) Pub. No.: US 2005/0254479 A1
(43) Pub. Date: Nov. 17, 2005

(54) Wireless digital communication system and method thereof

(75) Inventors: Fen-Man Chang, Hsinchu (TW); Chien-Yi Kuo, Shi Chih City (TW)

Correspondence Address: BRUCE H. TROXELL;SUITE 1404, 5205 LEESBURG PIKE, FALLS CHURCH, VA, 22041, US

(73) Assignee: AIPTEK International Inc.

(21) Appl. No.: 10/843,324

(22) Filed: May 12, 2004

(51) Int. Cl. H04J 3/16

(52) U.S. Cl. 370/346; 370/392; 370/469

(57) ABSTRACT

The invention is to provide a wireless digital communication system and method thereof using a first protocol layer, a second protocol and a third protocol layer for constructing a packet, wherein the first protocol layer is used to convert the packet into signals transmitted by a transmission medium, and the second protocol layer having addressing capability provides routing and switching functions necessary to move data from any two nodes in a network, and the third protocol layer is used to build a pairing mechanism between intermediary nodes in the network and between the original network with an external system on the packet. The three protocol layers of the present invention is designed according to a pairing mechanism such that the wireless product using the pairing mechanism can use the simplified protocol of the present invention instead of the conventional redundant communication protocol model.

### 1. FIELD OF THE INVENTION

The present invention relates to a wireless digital communication system and method thereof, and more particularly, to a wireless digital communication system and method thereof capable of using a simplified communication protocol stack by designing the same on a pairing mechanism.

### 2. BACKGROUND OF THE INVENTION

A network consists of two or more computers (such as PCs, MACs, UNIX workstations, etc.) that are linked by common transmission media in order to share resources (such as printers and CD-ROMs), exchange files, or allow electronic communications. The computers on a network may be linked through cables, telephone lines, radio waves, satellites, or infrared light beams.

In a network, when a computer A intends to communicate with a computer B for resource sharing, e.g. the computer A wants to send a “request” or “data” to the computer B through cables or telephone lines, the computer A is required to be enabled for the sending operation and the computer B is required to be able to acknowledge the request or data sent from the computer A and send a feedback to the computer A.

By the same principle, a computer can communicate with any computer in the world using one or more application software with specific function or I/O management capability. A network protocol is a set of predetermined rules that allow two entities to communicate. Two computers set up to use the same protocol will know what messages to expect and how to respond. But two computers set up to use two different protocols will not be able to communicate even if they are on the same physical network and use the same cabling scheme.

The Open Systems Interconnect (OSI) reference model is the International Standards Organization (ISO) structure for the “ideal” network architecture. This Model outlines seven areas, or layers, for the network and defines the data format, i.e. packet format, transmitting between computers in the network. Please refer to FIG. 1, which shows an OSI reference model. Seven layers are defined in the OSI Reference Model. The bottom four layers, i.e. physical, data link, network and transport, are concerned with the physical connection between computers and the reliable transmission of data between them. The top three layers, i.e. session, presentation and application, are concerned with the meaningful and cooperative exchange of information between computers. While a detailed description of the structure and function of each layer is beyond the scope of this document, it is useful to briefly describe each layer and the specific function it performs (as seen in FIG. 1):
Physical Layer: This layer handles the mechanical and electrical aspects of the physical connections made to the computer system. It sends and receives streams of binary digits (bits) across a physical medium, be it cable, optical fibre or a radio link.
Data-link Layer: This layer ensures error-free transmission of data between two directly connected systems. It includes functional and procedural means to transfer blocks of data and to detect and correct errors which may have occurred in the physical transmission of the data.
Network Layer: This layer with addressing capability provides routing and switching functions necessary to move data from an originating system through intermediary nodes to the destination system when there is no direct communication between two systems. It also is responsible for segmentation of the data within a message and its reassembly at the receiving system.
Transport layer: This layer is essentially the link between the upper and lower parts of the model. It provides end-to-end control of a communication channel once the path has been established. It enables the reliable and sequential exchange of data between the end systems.
Session Layer: The session layer establishes and manages a dialogue between communicating end systems. For example, it can allow simultaneous two-way communication or two-way alternative communications. It also provides mechanisms for recovery and resynchronization in case a connection has been lost.
Presentation Layer: This layer ensures that information is transferred in a format that can be processed by different, possibly incompatible, computer systems. It selects the appropriate syntax for data representation and, if needed, converts from a standardized representation used in communications to a representation that the local system can process.
Application Layer: This is the highest and most complex layer of the OSI Reference Model. It specifies what communication services are to be available to a computer system to allow it to co-operate with other systems in carrying out tasks, such as interpersonal messaging between users, managing interlibrary loan transactions, and transferring cataloguing records.

The establishment of the OSI reference model facilitates multi-vendor equipment interoperability and thus enables communication between hardware and software systems despite differences in underlying architectures.

Up until recently, wireless technology was a patchwork of incompatible systems from a variety of vendors. The technology was slow, expensive and reserved for mobile situations or hostile environments where cabling was impractical or impossible. With the maturing of wireless networking standard cooperating wireless datagram protocol (WDP) with the foregoing communication protocol, wireless technology has produced a number of affordable wireless solutions that are growing in popularity with our daily life. For instance, a wireless network can use an access point acted like a hub, providing connectivity for the wireless computers. It can connect (or “bridge”) the wireless LAN to a wired LAN, allowing wireless computer access to LAN resources, such as file servers or existing Internet Connectivity.

Please refer to FIG. 2, which is a schematic diagram showing an wireless enabled notebook computer accessing to an existing Internet Connectivity through a wireless network. When a wireless enabled notebook computer 210 uses an access point 213 to have access to an existing Internet Connectivity so as to connect with a server 220, the data link between the notebook computer 210 and the access point 213 is established by the IEEE 802.112/9 protocol on the physical layer and the data-link layer of the OSI reference model, and the data link between the access point 213 and the dynamic host configuration protocol server 230 is established by the WDP/IP protocol, such that the notebook computer 210 can obtained an IP address assigned by the dynamic host configuration protocol server 230 and thus establish a data linkage with the server 220 by way of the access point 213. It is noted that the data linkage between the notebook computer 21 and the server 220 is established by a TCP/IP protocol which is similar to the OSI reference model.

In this regard, the wireless enabled notebook computer 210 is linked with the server 220 on the other side of the internet 215 using the wireless networking architecture of FIG. 2.

However, the more layers the communication protocol has, the more payload the wireless network is required to process and thus the network will require to be equipped with more sophisticated devices for handling such massive payload.

When the wireless network using a multi-layer communication protocol similar to the TCP/IP model is being applied on a certain wireless communication product, such as a monitoring system consisted of video cameras and monitors, even the monitoring system is a simple wireless product comparing to the other wireless communication products, there is still a massive data payload required to be processed. In reality, the certain simple wireless product only uses a portion of the services provided by the multi-layer protocol, such as the TCP/IP model. Hence, if the certain simple wireless product applies the multi-layer protocol similar to the TCP/IP model, some extra cost will be spent on handling those redundant services came with the multi-layer protocol.

In view of the above description, the present invention provides a wireless digital communication system and method thereof, requiring no multi-layer protocol similar to the TCP/IP model, capable of being applied on those simple wireless products for reducing the manufacturing cost.

### SUMMARY OF THE INVENTION

The primary object of the invention is to provide a wireless digital communication method using a first protocol layer, a second protocol and a third protocol layer for constructing a packet, wherein the first protocol layer is used to convert the packet into signals transmitted by a transmission medium, and the second protocol layer having addressing capability provides routing and switching functions necessary to move data from any two nodes in a network, and the third protocol layer is used to build a pairing mechanism between intermediary nodes in the network and between the original network with an external system on the packet.

In a preferred embodiment of the present invention, the network comprising a host and at least a device implements a pairing mechanism as following: sending a request from the host to the device; sending a response from the device to the host; sending a packet from the device to the host; sending an update from the host to the device.

Both the second protocol layer and the third protocol layer will build headers on the transmitted packet. The header built by the second protocol layer includes a Preamble field, a Net ID field, a Node ID field, a PacketSize field, etc., and the header built by the third protocol layer includes a Category field, a Command/Response field, a Sequence ID/Flag field and a Length field, etc. In addition, the category is used for identify the category of the packet, and there are four categories: CONFIG, CTRL, DATA, FIRMWARE.

The third protocol layer uses the least significant 2 bits to clarify command and response, representing meanings of the following: the command is being processed, the command is successfully processed, the data payload is wrong, and the command cannot be recognized (which are referred respectively as CMD, ACK, NAK, and REJ hereinafter). If the category field is belonged to DATA, a flag of most significant 2 bits will be used to specify the begin of data and the end of data. On the other hand, if the category field is belonged to firmware, the most significant 2 bits will be used to specify begin/end, and the remaining 6 bits will be used for the sequence ID.

Another object of the present invention is to provide a wireless digital communication system, comprising a host and at least a device, wherein the host is configured in a network having at least a device paired with the host by a pairing mechanism such that a packet is being transmitted between the host and the device using a three-layer protocol.

In a preferred embodiment of the present invention, the host is a monitor and the device is a video camera.

To sum up, the present invention provides a wireless digital communication system and method thereof capable of using a three-layer protocol by designing the same on a pairing mechanism so as to reduce the cost required for data processing.

### BRIEF DESCRIPTION OF THE DRAWINGS

FIG. 1 shows an OSI reference model

FIG. 2 is a schematic diagram showing an wireless enabled notebook computer accessing to an existing Internet Connectivity through a wireless network.

FIG. 3 shows a pairing mechanism of a monitoring system according to a preferred embodiment of the present invention.

FIG. 4 is a header of a packet for addressing according to the second protocol layer and the third protocol layer of a preferred embodiment of the present invention.

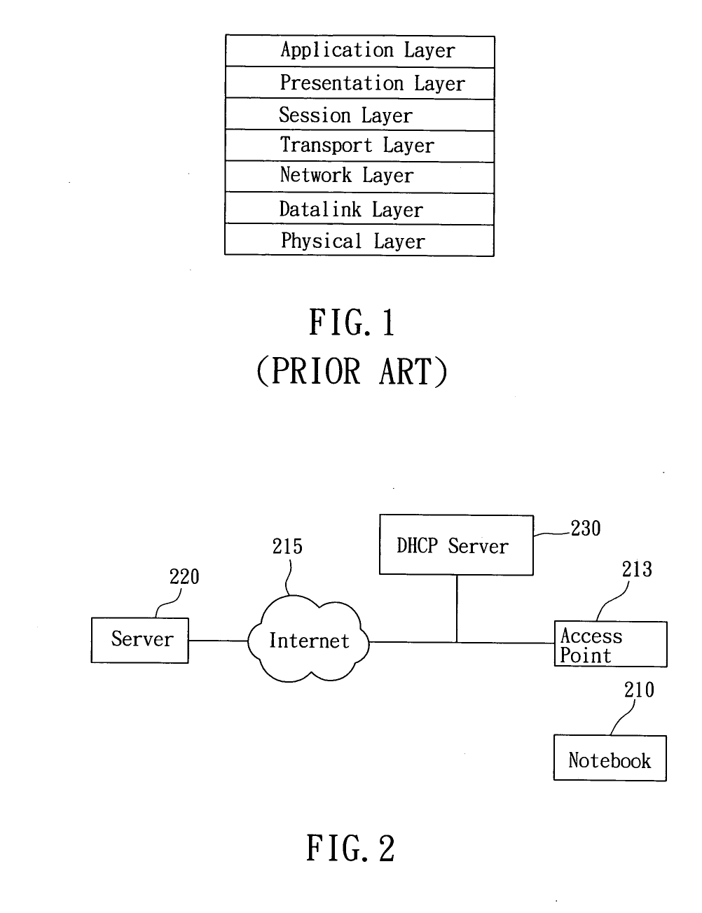

### DESCRIPTION OF THE PREFERRED EMBODIMENT

In a simple wireless product, such as a monitoring system consisted of video cameras and monitors, the communication between the host and the device is based on a pairing mechanism. Therefore, if a simplified protocol instead of the complicated multi-layer TCP/IP model can be defined according to the pairing mechanism for the simple wireless communication product, such as the monitoring system, the extra cost spent on handling those redundant protocol came with the multi-layer communication model can be minimized.

Accordingly, the present invention provides a wireless digital communication method using a first protocol layer, a second protocol and a third protocol layer for constructing a packet, wherein the first protocol layer is used to convert the packet into signals transmitted by a transmission medium, and the second protocol layer having addressing capability provides routing and switching functions necessary to move data from any two nodes in a network, and the third protocol layer is used to build a pairing mechanism between intermediary nodes in the network and between the original network with an external system on the packet.

When the present invention is being implemented onto a network whose host communicates with a device thereof according to a pairing mechanism, such as a monitoring system with a monitor as the host and a video camera as the device, the layers of the communication protocol used in the network can be simplified and reduced such the complicated multi-layer TCP/IP model is not required.

To make the esteemed review committee can further understand and recognize the present invention, a detailed description in accordance with several accompanying diagrams are presented as following.

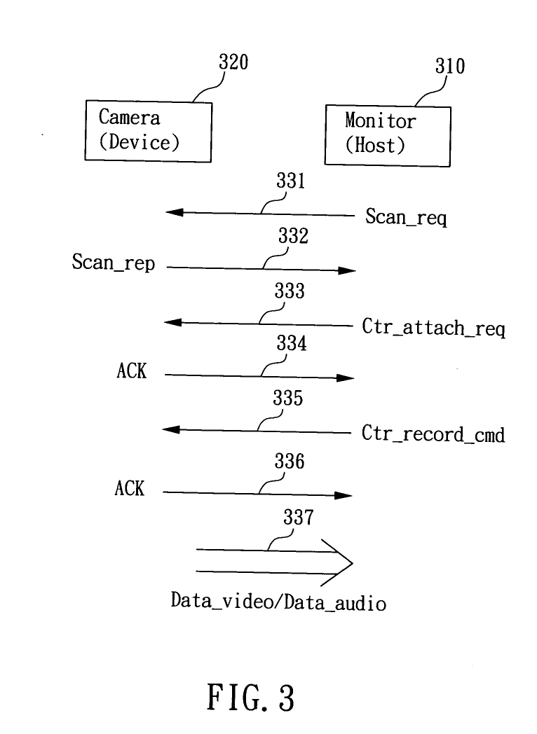

Please refer to FIG. 3, which shows a pairing mechanism of a monitoring system according to a preferred embodiment of the present invention. The network of the monitoring system comprises a monitor 310 and at least a video camera 320. When the monitor 310 wants to monitor each video camera 320 configured on a node of the network, the monitor 310 will issue a scan request, i.e. a Scan_req 331, to each node of the network for detecting the existence of video cameras 320 in the network. As soon as a video camera 320 receives the Scan_req 331, the video camera 320 will issue a scan response, i.e. a Scan_rsp 332, back to the monitor 310 to inform the monitor 310 of its availability.

Following, the monitor 310 can start the procedure of receiving images from the scanned video camera 320. First, the monitor 310 will send a file-attach request, i.e. Ctr_attach_req 333, to the specific video camera 320, and the video camera 320 after receiving the Ctr_attach_req 333 and finishing all the corresponding actions will return an ACK 334 to inform the monitor 310 that it is ready for the image transmission.

After the ACK 334 is received by the monitor 310, a recording command, i.e. Ctr_record_cmd 335 will be sent from the monitor 310 to the specific video camera 320 for instructing the same to start the image transmission. When video camera 320 receives the Ctr_record_cmd 335, it will issue an ACK first to the monitor 310 and than start transmitting image data 337 to the monitor 310.

Hence, by the aforementioned pairing mechanism, the monitor 310 is capable of acquiring image data 337 taken by the video camera 320.

Intuitively, while comparing the data transmission between the monitor 310 and the video camera 320 with that between the notebook computer 210 and the server 220, the major difference between the foregoing monitoring system with pairing mechanism and the system shown in FIG. 2 is that the monitoring can do without the procedure of obtaining an IP address from the DHCP server 230. Therefore, while applying the present invention on the monitoring system with pairing mechanism, the medium access control (which is referred as MAC layer hereinafter), which is the second layer of the TCP/IP model, can be used for providing addressing service to the packet being transmitted between any two nodes hooked to the network of the monitoring system, and any layers beyond the third layer of the TCP/IP model are clustered and simplified into a layer for building a pairing mechanism between intermediary nodes in the network and between the original network with an external system on the packet.

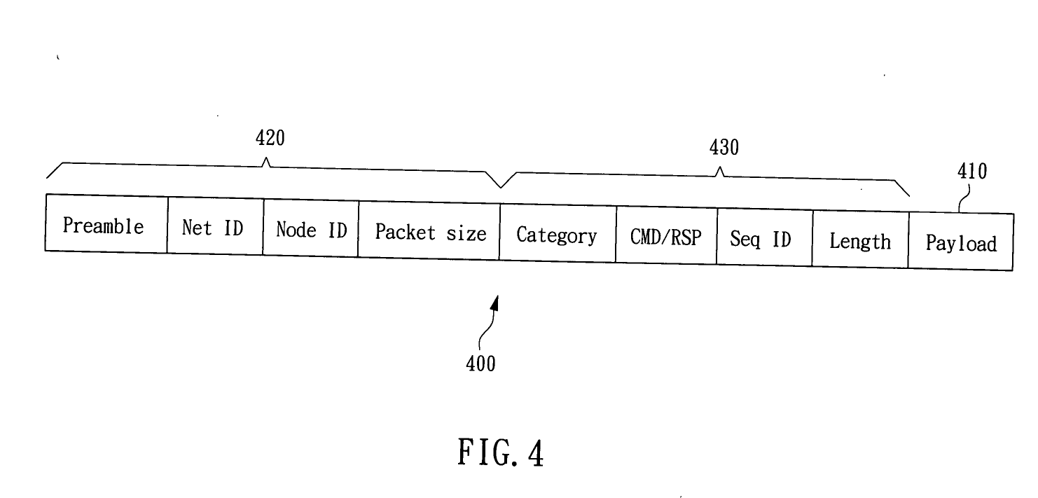

Please refer to FIG. 4, which is a header of a packet for addressing according to the second protocol layer and the third protocol layer of a preferred embodiment of the present invention. As seen in FIG. 4, The header 420 built by the second protocol layer before the payload 410 of the packet 400 comprises a Preamble field, a Net ID field, a Node ID field, a PacketSize field, and the header 430 built by the third protocol layer before the payload 410 of the packet 400 comprises a Category field, a Command/Response field, a Sequence ID/Flag field and a Length field

Wherein, the Preamble field is used for synchronization, and the Net ID field is used for specifying the network (host) ID the packet 400 belongs to, and the Node ID field is used for specifying the device ID the packet 400 originated or destinated, and the PacketSize field is used for specifying the length of the packet 400.

The category field of the header 430 is used for identifying the category of the packet 400, and there can be four categories: CONFIG, CTRL, DATA, FIRMWARE.

The Command/Response field of the header 430 carries the command or response required by the category filed, such as the Scan_req 331, the Scan_rsp 332, and Ctr_attach_req 333, etc. of FIG. 3. The Sequence ID/Flag field is used for specifying the begin/end of a packet.

Moreover, the Command/Response field can be configured as following:

| | |
|---|---|
| CONFIG: | 0 × 10 |
| CTRL: | 0 × 20 |
| DATA: | 0 × 30 |
| FIRMWARE: | 0 × 40 |

In general, the Command/Response field uses the least significant 2 bits to clarify the command and response, such as ACK, NAK and REJ, or uses the most significant bit to clarify a receiving and transmitting.

The Sequence ID/Flag field of the header 430 is used for specifying the sequence of a plurality of packets. For instance, if the category is belonged to DATA, the flag will be used for specifying the packet, and if the category is belonged to the categories other than DATA, the sequence ID will be use specifying the sequence of a plurality of packets, in this regard, the host will generate the sequence ID and increase the value by 1 for next command. As for the length field of the header 430 is only to describe the length of payload 410.

In most case, the header built by the third protocol layer of the present invention as seen in FIG. 4 is generally sufficient for the transmission between paired nodes of the monitoring system. Thus, the present invention used the foregoing third protocol layer along with the MAC layer and the physical layer to form a communication protocol stack for those simple wireless communication products.

Hence, the present invention provides a wireless digital communication method capable of using a simplified communication protocol stack by designing the same on a pairing mechanism, moreover, the simplified protocol stack is formed by integrating communication protocols needed for the pairing mechanism on the third protocol layer and deleting the layers beyond the third layer, such that the system using the pairing mechanism can implement a simplified communication protocol stack for achieving wireless communication. In addition, the payload of the system can be reduced since redundant protocols are deleted and the protocols corresponding to the pairing mechanism are integrated into a layer. In this regard, a certain lower level devices can be used in the wireless system for implementing the simplified protocol stack corresponding to the pairing mechanism, and the overall production cost of the wireless system, e.g. household wireless device, such as baby monitor system, is greatly reduced. To sum up, the present invention provides a wireless digital communication system and method thereof capable of using a simplified communication protocol stack by designing the same on a pairing mechanism, wherein the simplified communication protocol stack is formed with a MAC layer, a physical layer, and a third protocol layer built by integrating and simplifying the layers beyond the third layer of a conventional communication protocol stack according to the pairing mechanism. Comparing to the convention multi-layer protocol model, the packet size of the present invention is much smaller than that of prior art since the communication protocol stack of the present invention only has three layers. Thus, the wireless system using the present invention can have lighter payload and is capable of using lower cost device for handling the packet transmission.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. A wireless digital communication method for processing a packet transmitted between intermediary nodes of a network, comprising:
using a first protocol layer, a second protocol and a third protocol layer for constructing the packet, wherein the first protocol layer is used to convert the packet into signals transmitted by a transmission medium, and the second protocol layer having addressing capability provides routing and switching functions necessary to move data from any two nodes in the network, and the third protocol layer is used to build a pairing mechanism between intermediary nodes in the network and between the network with an external system on the packet.

2. The wireless digital communication method of claim 1, further comprising:
constructing a header on the packet according to the second protocol layer.

3. The wireless digital communication method of claim 2, wherein the head includes: a preamble field, a Net ID field, a Node ID field, and a packet size field.

4. The wireless digital communication method of claim 1, while the network comprises a host and at least a device, the pairing mechanism includes the step of:
sending a request from the host to the device;
sending a response from the device to the host;
sending a data from the device to the host;
sending an update from the host to the device.

5. The wireless digital communication method of claim 4, further comprising:
constructing a header on the packet according to the third protocol layer.

6. The wireless digital communication method of claim 5, wherein the header includes: a category field, a command/response field, a sequence ID/Flag field, and a length field.

7. The wireless digital communication method of claim 6, wherein the category filed is one of the following: CONFIG, CTRL, DATA, and FIRMWARE.

8. The wireless digital communication method of claim 6, wherein the command/response field uses the least significant 2 bits.

9. The wireless digital communication method of claim 8, wherein the least significant 2 bits is used for specifying following: the command is being processed, the command is successfully processed, the data payload is wrong, and the command cannot be recognized.

10. The wireless digital communication method of claim 7, wherein 2 bits is being used as a flag when the category field is belonged to DATA.

11. The wireless digital communication method of claim 10, wherein the 2 bits is used for specifying the following: the beginning bit of a fragment data, the ending bit of a fragment data.

12. The wireless digital communication method of claim 7, wherein when the category field is belonged to FIRMWARE, the sequence ID/Flag field uses 2 bits as flag and the remaining 6 bits for a sequence ID.

13. A wireless digital communication system, comprising:
a host; and
at least a device;
wherein the host is configured in a network having at least a device paired with the host by a pairing mechanism such that a packet is being transmitted between the host and the device using a three-layer protocol stack.

14. The wireless digital communication system of claim 13, wherein the host is a monitor.

15. The wireless digital communication system of claim 14, wherein the device is a video camera.

16. The wireless digital communication system of claim 13, wherein the three-layer protocol stack comprises a first protocol layer, a second protocol and a third protocol layer, and the first protocol layer is used to convert the packet into signals transmitted by a transmission medium, and the second protocol layer having addressing capability provides routing and switching functions necessary to move data from any two nodes in the network, and the third protocol layer is used to build a pairing mechanism between intermediary nodes in the network and between the network with an external system on the packet.
